(19) United States
(12) Patent Application Publication
(10) Pub. No.: US 2015/0059692 A1
(43) Pub. Date: Mar. 5, 2015

(54) SPEED CONTROLLER AND METHOD FOR IMPROVING THE TRANSIENT STATE OF A SPEED CONTROLLER

(71) Applicant: SCANIA CV AB, Södertälje (SE)

(72) Inventors: Oskar Johansson, Stockholm (SE); Mikael Ögren, Norsborg (SE); Martin Evaldsson, Nacka (SE)

(21) Appl. No.: 14/383,991

(22) PCT Filed: Feb. 26, 2013
(86) PCT No.: PCT/SE2013/050167

§ 371 Date: Sep. 9, 2014

(30) Foreign Application Priority Data
Mar. 27, 2012 (SE) 1250299-3

(51) Int. Cl. F02D 31/00

(52) U.S. Cl. CPC F02D 31/001
USPC 123/350

(57) ABSTRACT

A speed regulator 120 and a method for operating it. The speed regulator guides an engine system 130 in a vehicle towards a target speed v_{des}, whereby the vehicle assumes an actual speed v_{act} which describes a zeroing pattern towards the target speed v_{des}. Priming of the speed regulator 120 is effected on the basis of knowledge about a road section ahead of the vehicle, whereby the magnitude of at least one fluctuation in the zeroing pattern relative to the target speed v_{des} is reduced. A zeroing pattern with fewer overshoots and undershoots is thus achieved, resulting in reduced fuel consumption.

### TECHNICAL FIELD

The present invention relates to a method for a speed regulator according to the preamble of claim 1, and a speed regulator according to the preamble of claim 17.

The present invention relates also to a computer programme and a computer programme product which implement the method according to the invention.

### BACKGROUND

In motor vehicles, e.g. cars, trucks and buses, an engine system is usually controlled by means of a regulator, a so-called speed regulator, which may be situated in a control unit of the vehicle but may also be situated elsewhere on board. The speed regulator regulates a torque which is demanded from the engine system and which usually varies over time, e.g. when the speed of a vehicle has to be altered or the vehicle comes to an upgrade or a downgrade.

Cruise control is now usual in motor vehicles such as cars, trucks and buses. One purpose of cruise control is to achieve a uniform predetermined speed either by adjusting the engine torque to avoid deceleration or by applying brake action on downhill runs where the vehicle is accelerated by its own weight. A more general purpose of cruise control is to provide the vehicle's driver with easy driving and more comfort.

FIG. 1 depicts schematically part of a cruise control system 100 in which a driver of a motor vehicle with a cruise control 110 usually chooses a set speed vₛₑₜ which he/she wishes the vehicle to maintain on level roads. The cruise control 110 then conveys to a speed regulator 120 a reference speed v_{ref}, i.e. a target speed v_{des}, which may be regarded as a set-point value for the vehicle's speed. The reference speed v_{ref} is used by the speed regulator to determine a torque M which it demands from an engine system 130 of the vehicle. The result of this torque demanded M is the actual speed v_{act} which the vehicle consequently assumes.

The set speed vₛₑₜ may therefore be regarded as an input signal to the cruise control, and the reference speed v_{ref} as an output signal from the cruise control, which is used as a target speed v_{des} for control of the engine by means of the speed regulator. In other words, the reference speed v_{ref} here serves as the set-point value for the vehicle's speed and is herein also referred to as the target speed v_{des}.

One skilled in the art will appreciate that the cruise control 110 may also be replaced by a command from the driver. Thus the target speed v_{des} may also be conveyed to the speed regulator 120 as a result of the driver operating the vehicle's controls, e.g. an acceleration control such as an accelerator pedal or the like.

In today's traditional cruise controls (CCs) the reference speed v_{ref} is identical with the set speed vₛₑₜ chosen by the user of the system, e.g. a driver of the vehicle. They therefore maintain a constant reference speed v_{ref} corresponding to the set speed vₛₑₜ chosen by the driver. The value of the reference speed v_{ref} here changes only when adjusted by the user during the journey.

There are today cruise controls known as economical cruise controls, e.g. Ecocruise and the like, which try to estimate current running resistance, also have knowledge about the historical running resistance and allow the reference speed v_{ref} to differ from the set speed vₛₑₜ chosen by the driver. A cruise control which allows this difference is herein referred to as a reference-speed-regulating cruise control.

### BRIEF DESCRIPTION OF THE INVENTION

A general problem with regulators is that they often generate fluctuations, so-called overshoots and undershoots of the current-value signal, at steps, i.e. at relatively rapid changes, in the regulating signal which serves as the set-point value signal. These fluctuations are due inter alia to inertia in systems governed by the regulator. FIG. 2 depicts schematically by way of example such an undershoot 204 and overshoot 205 which illustrate an example of the result of the inertia of a fictitious system when the regulator signal takes a step 203 from a first level 201 to a second level 202.

In the case of a speed regulator in a motor vehicle, inertia in the engine system's torque build-up may contribute to fluctuations of the actual speed v_{act} about a target speed v_{des}, i.e. fluctuations about a set-point value v_{des} for the vehicle's speed v_{act}. The torque build-up in an engine system in a vehicle is often limited by rules and/or legal requirements which for example impose limits on the amounts of exhaust gases which the vehicle is allowed to discharge. The engine system's torque build-up thus becomes so slow that fluctuations about the speed regulator's target speed often occur.

This means that the speed regulator 120 which controls the engine system 130 functions suboptimally and that fuel consumption related to running time per energy unit increases, since fuel has to be consumed to increase the actual speed v_{act}, i.e. the actual value of the vehicle's speed, from an undershoot speed to the target speed v_{des}, i.e. the set-point value for the vehicle's speed.

The inertia in a vehicle's engine system thus causes fluctuations in the form of at least one undershoot and/or overshoot in a zeroing pattern for the actual speed v_{act}, which is regulated by a speed regulator towards a target speed v_{des}, leading to increased fuel consumption.

An object of the present invention is to improve the zeroing pattern for the actual speed v_{act} towards the target speed v_{des} and thereby also reduce fuel consumption.

This object is achieved by the abovementioned method for a speed regulator according to the characterising part of claim 1. It is also achieved by means of the aforesaid speed regulator according to the characterising part of claim 17.

The vehicle employs a priming of the speed regulator on the basis of knowledge about road sections ahead. This priming causes the regulator to execute a guiding measure earlier on the basis of knowledge about road sections ahead than it would if it had no such knowledge or ignored it. The priming may also be regarded as anticipating a demand for torque from the engine system.

The present invention achieves a zeroing pattern with fewer overshoots and undershoots and hence less fuel consumption. The fact that the speed regulator is primed with a torque demand which anticipates the vehicle's actual speed v_{act} when it zeroes in towards the target speed v_{des} reduces or eliminates one or more overshoots and undershoots in the zeroing pattern.

Regulation according to the present invention causes the vehicle's actual speed v_{act} to zero in smoothly and substantially without fluctuations towards the target speed v_{des}, resulting in various advantages. One advantage is that such a smooth zeroing pattern is fuel-efficient. Another is that a smoother zeroing pattern results in greater comfort for the vehicle's driver by minimising speed variations. This smoother zeroing pattern also provides the driver with better understanding of the regulator's function, since it corresponds to a pattern which the driver would intuitively have tried to follow if he/she regulated the vehicle's actual speed v_{act} without cruise control or regulator assistance.

### BRIEF LIST OF DRAWINGS

The invention is explained in more detail below with reference to the attached drawings, in which the same reference notations are used for similar items, and

FIG. 1 is a schematic diagram of a cruise control, a speed regulator and an engine system,

FIG. 2 depicts an example of overshoot and undershoot of a regulating curve,

FIG. 3 depicts examples of zeroing patterns,

FIG. 4 depicts an example of topography, engine torque and zeroing pattern for the vehicle's speed,

FIG. 5 depicts a control unit according to the present invention.

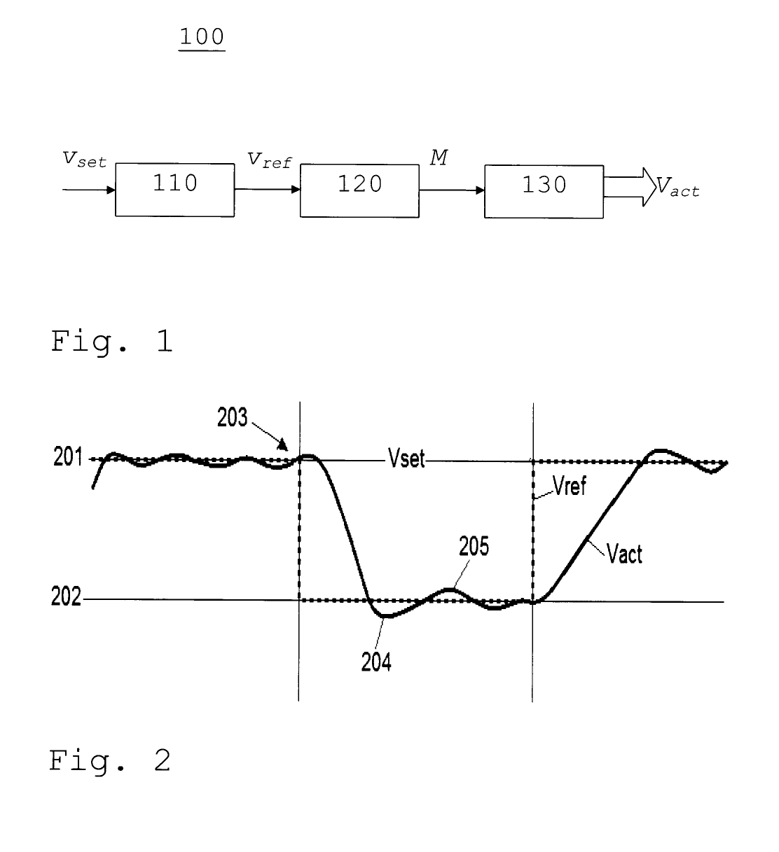

### DESCRIPTION OF PREFERRED EMBODIMENTS

One aspect of the present invention proposes a method for a speed regulator 120 and, in more detail, a method for the speed regulator's guidance of a zeroing pattern for a vehicle's actual speed v_{act} towards a target speed v_{des}. The invention uses knowledge about a road section ahead of the vehicle to effect a priming of the speed regulator. This knowledge may be of various different kinds, e.g. knowledge about road gradient or curvature. Priming means here that the speed regulator executes at least one guiding measure earlier than if said knowledge about said road section ahead was ignored. The speed regulator is thus here at least one measure early on the basis of said knowledge.

This priming of the speed regulator makes it possible to reduce the magnitude of at least one fluctuation of the zeroing pattern for the actual speed v_{act} relative to the target speed v_{des.}

This is illustrated schematically in FIG. 3, in which the vehicle's actual speed when the present invention is not applied is represented by the curve v_{act}_{_{—}}₁. This curve has a number of overshoots and undershoots, i.e. fluctuations in its zeroing pattern towards the target speed v_{des}, caused by the slow torque build-up in the vehicle's engine system in combination with the configuration of road sections ahead. The curve v_{act}_{_{—}}₁ may for example present this kind of configuration where road sections ahead comprise an upgrade. It may be noted that a fluctuating speed, e.g. a fluctuating zeroing pattern, is not optimum from a fuel consumption perspective, since a considerable amount of brake energy is braked away during overshoots of the fluctuating speed. If for example the driver does not wish to exceed 90 km/h, he/she has to brake energy away if overshoots go above 90 km/h, but can avoid braking if they reach only 89 km/h. Moreover, a fluctuating zeroing pattern in the form of undershoots and/or overshoots is suboptimum from the fuel perspective in that deviation from an average speed for the vehicle results in squaring of terms for the losses, e.g. for the air resistance.

The curve v_{act}_{_{—}}₂ illustrates a corresponding zeroing pattern when the present invention is applied. In this case the speed regulator is thus primed so that at least one guiding measure is executed early on the basis of knowledge about road sections ahead. The speed regulator may for example cause the torque build-up in the engine system to begin earlier than if no account was taken of knowledge about the road section ahead. Here a demand for engine torque is thus anticipated, and the magnitude of the torque thus demanded earlier will counteract one or more fluctuations of the curve for the actual speed v_{act}_{_{—}}₁. As illustrated in FIG. 3, the earlier torque build-up here for example makes it possible for the first large undershoot of the curve v_{act}_{_{—}}₁ to be completely eliminated when the present invention is applied. The priming of the speed regulator according to the present invention may be regarded as an intelligent PID regulator, as described in more detail below.

Other overshoots and undershoots in the zeroing pattern for v_{act}_{_{—}}₁ are also avoided in the pattern v_{act}_{_{—}}₂ which results from the present invention. As the schematic FIG. 3 indicates, curve v_{act}_{_{—}}₂ approaches the target speed v_{des} without overshoots or undershoots, which means that this pattern reduces fuel consumption compared with the fluctuating pattern of curve v_{act}_{_{—}}₁ when the invention is not employed. The smoother pattern resulting from the present invention's priming (anticipation) of the torque demand to the engine system also provides a driver of the vehicle with more comfort and better understanding of the regulator's function.

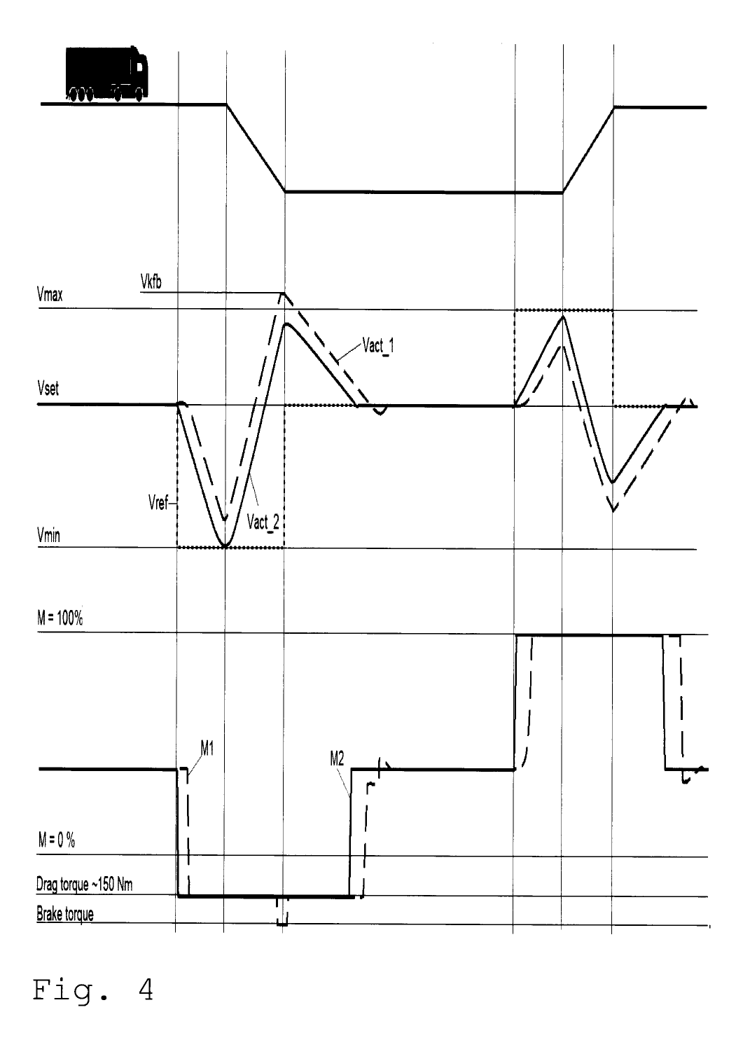

FIG. 4 illustrates in more detail a non-limitative schematic example of how topography, vehicle speed and torque are inter-related. The top part of the diagram depicts an example of topography of a road on which the vehicle travels. Depicted below this are a target speed vₛₑₜ, a reference speed v_{ref} which a reference-speed-regulating cruise control provides for this topography, a lowest permissible speed vₘᵢₙ, a highest permissible speed vₘₐₓ and a constant-velocity brake speed v_{kfb}. Also depicted is the vehicle's actual speed v_{act}_{_{—}}₁ (broken line) as it would be if the present invention is not applied, and its actual speed v_{act}_{_{—}}₂ (continuous line) as it would be if the present invention is applied.

The bottom part of FIG. 4 illustrates the torque M1 (broken line) demanded from the engine system if the present invention is not applied, and the torque M2 (continuous line) demanded from the engine system if the present invention is applied. It shows clearly that the torque M2 according to the present invention varies between drag torque and maximum torque (M=100%) when the vehicle travels first downhill and then uphill. The torque M1 when the present invention is not applied varies between brake torque and maximum torque (M=100%) when the vehicle travels the same stretch of road. This is because its actual speed v_{act}_{_{—}}₁ when the present invention is not applied reaches the constant-velocity brake speed v_{kfb}. Thus no energy will be braked away when the present invention is applied, whereas a braking away of energy which is unjustifiable from a fuel perspective takes place when the present invention is not employed.

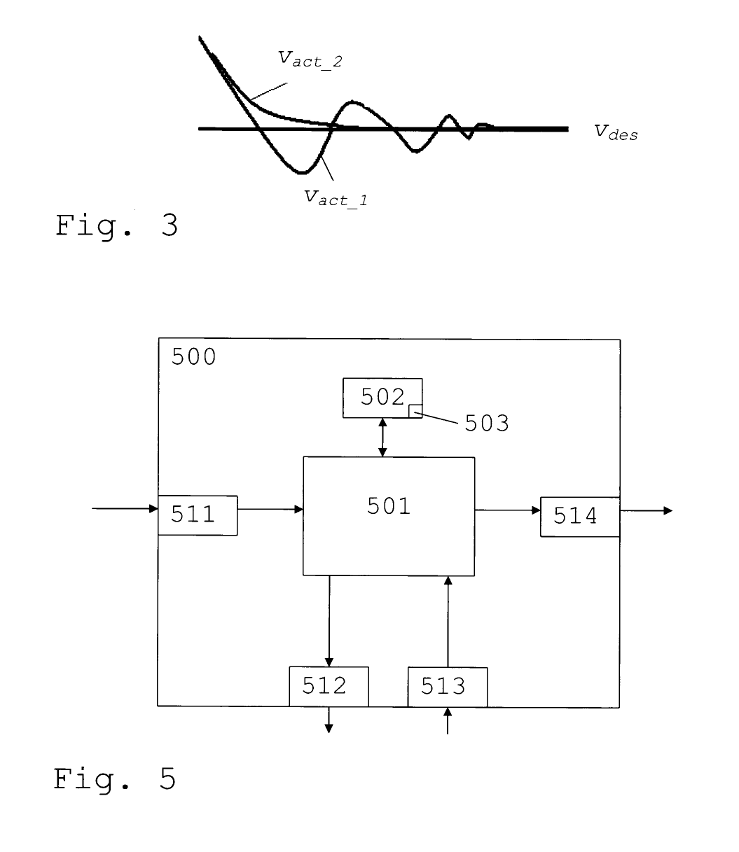

As previously mentioned, FIG. 4 is a schematic diagram illustrating various examples of situations where the present invention may with advantage be employed. As discussed in relation to FIG. 2, a situation such as illustrated in FIG. 4 involves, when using previous known systems, not only the problems here mentioned but also the problem of overshoots and undershoots of the vehicle's actual speed v_{act}_{_{—}}₁. These overshoots and undershoots are not depicted in detail in FIG. 4, since it is intended to make clear the problems of braking away of energy. It should however be noted here that when for example the actual speed v_{act}_{_{—}}₁ reaches the constant-velocity brake speed v_{kfb} it will present a fluctuating zeroing pattern in that the actual speed v_{act} has then to be greatly reduced. An overshoot for the actual speed v_{act}_{_{—}}₁ will therefore here exceed the constant-velocity brake speed v_{kfb} and have to be braked away. As described previously, the present invention does not have this problem.

Braking away of energy may therefore be avoided when the present invention is employed, not only because the torque M2 demanded from the engine system does not go down to the vehicle's brake torque but also because overshoots and/or undershoots in the zeroing pattern at speed changes can be avoided.

The present invention thus uses knowledge about a road section ahead to effect a priming of the speed regulator. Such knowledge may be about one or more from among topography, road curvature, traffic situation, roadworks, traffic density and road surface state.

Such knowledge about road sections ahead is also used in certain cruise controls known as economical cruise controls. An example of such a further development of an economical cruise control is a “look ahead” cruise control (LACC), i.e. a strategic cruise control which uses knowledge about road sections ahead, i.e. knowledge about the nature of the road in front, to determine the configuration of the reference speed v_{ref}. Here the reference speed v_{ref} is therefore allowed, within a certain range, to differ from the set speed vₛₑₜ chosen by the driver, in order to achieve more fuel economy.

Knowledge about the road section ahead which is used in LACCs may for example comprise prevailing topography, road curvature, traffic situation, roadworks, traffic density and road surface state. It may also comprise a speed limit on the road section ahead, and a traffic sign beside the road. One embodiment of the present invention uses at least one of these kinds of knowledge in the priming of the regulator. This is highly advantageous and computationally efficient, since these kinds of knowledge are readily available on board the vehicle. They may therefore be used here for various purposes, both for cruise control and for the priming of the speed regulator. The priming according to the present invention may thus be implemented with very little in terms of extra calculations or complexity.

These kinds of knowledge may for example be obtained by means of location information, e.g. GPS (global positioning system) information, map information and/or topographical map information, weather reports, information communicated between vehicles and information communicated by radio.

Substantially all relatively large changes in the actual speed v_{act} may result in fluctuations in the zeroing pattern of the actual speed towards the target speed v_{des} if the present invention is not applied. Knowledge about road sections ahead is used to be able to identify these relatively large changes.

For example, information about the topography of road sections ahead may be used to identify upgrades and/or downgrades on which relatively large changes in speed often occur, as depicted in FIG. 4. Overshoots and undershoots typically occur close to the beginning of an upgrade because the vehicle's actual speed v_{act} changes. They similarly occur close to the beginning of a downgrade because the actual speed changes.

If a reference-speed-regulating cruise control is used in the vehicle, the change in the actual speed v_{act} may be because the reference speed v_{ref}, which then corresponds to the target speed v_{des}, changes relative to the set speed vₛₑₜ.

In a similar way, information about curvature of road sections ahead may be used to identify coming changes in speed caused by the fact that the actual speed v_{act} often drops at bends, particularly sharp bends, before increasing again after them.

Similarly, information about traffic situations on road sections ahead may be used to identify coming changes in speed. Here knowledge about, for example, a red traffic light ahead may conceivably be used to identify at least one likely change in speed close to the red light.

Knowledge about roadworks ahead may also be used to identify coming changes in speed, since there are usually speed limits close to roadworks.

Information about traffic density on road sections ahead may also be used to identify coming changes in speed, since traffic queues will for example make it necessary to reduce speed, and a cessation of queuing will make it possible to increase speed.

The road surface state also affects vehicle speed, since a lower speed needs to be maintained where the surface state is bad, e.g. when there is ice, than where it is good. Information about the surface state of road sections ahead may thus also be used to identify coming changes in speed.

As mentioned above, the reference speed v_{ref} in today's traditional cruise controls is identical with the set speed vₛₑₜ chosen by the user of the system. In one embodiment of the present invention, the target speed v_{des} serves as such a set speed vₛₑₜ.

In reference-speed-regulating cruise controls, e.g. LACCs, the reference speed v_{ref} is allowed to differ from the set speed vₛₑₜ. In one embodiment of the present invention, the target speed v_{des} serves as such a reference speed v_{ref}.

As mentioned above, the priming of the speed regulator, which according to the invention is based on knowledge about road sections ahead, causes it to execute one or more guiding measures earlier than if such knowledge was ignored or not available. The priming according to the invention counteracts fluctuations in the zeroing pattern for the actual speed v_{act}.

In one embodiment of the invention, the priming is effected by changing the character of said speed regulator. The speed regulator will generally have a number of available regulating alternatives. Switching to a different alternative will alter the character of the speed regulator.

There are various types of regulators. We describe here the function and the algorithm of a PID regulator, but one skilled in the art will appreciate that the principle of priming the regulator according to the present invention may be implemented in substantially any kind of regulator.

Character change may be effected by altering the magnitude of one or more amplification parameters for a regulating algorithm of the speed regulator.

There are various types of regulators. We describe here the work and algorithm of a PID regulator, but one skilled in the art will appreciate that other types/variants of regulators work in similar ways. The present invention may be implemented for all such other types/variants of regulators.

A PID regulator is a regulator which gives an input signal u(t) to a system, e.g. the engine system 130, on the basis of a difference e(t) between a desired output signal r(t), which in this specification corresponds to the target speed v_{des}, and an actual output signal y(t) which in this specification corresponds to the actual speed v_{act}. In the case referred to below, e(t)=r(t)−y(t) according to

$$u ( t ) = {K}_{p} e ( t ) + {K}_{I} {\int }_{0}^{t} e ( τ ) d τ + {K}_{D} \frac{d e ( t )}{d t} \qquad ( eq . 1 )$$

in which
Kₚ is an amplification constant,
K_{I} an integration constant, and
K_{D} a derivation constant.

A PID regulator regulates in three ways, viz. by a proportional amplification (P; Kₚ), by an integration (I; Kᵢ) and by a derivation (D; K_{d}).

The constants Kₚ, Kᵢ and K_{d} affect the system as follows.

An increased value for the amplification constant Kₚ leads to the following changes in the PID regulator:
increased rapidity,
reduced stability margins,
improved compensation of process disturbances, and
increased control signal activity.

An increased value for the integration constant Kᵢ leads to the following changes in the PID regulator:
better compensation of low-frequency process disturbances (eliminating residual errors due to step disturbances)
increased rapidity, and
reduced stability margins.

An increased value for the derivation constant K_{d} leads to the following changes in the PID regulator:
increased rapidity,
increased stability margins, and
increased control signal activity.

The regulating algorithm for a PID regulator is well-known to one skilled in the art, who will also be familiar, as mentioned above, with other types/variants of regulators/regulating algorithms and their similarities to/differences from the PID regulator.

As mentioned above, the priming of the speed regulator according to the present invention may be regarded as an intelligent PID regulator, here meaning a regulator which adjusts the amplifications Kₚ, K_{I}, K_{D} for the respective P, I and D elements on the basis of how the vehicle is predicted to behave at a relatively near future time. The prediction of the vehicle's coming behaviour may here be based on the aforesaid knowledge available at the time of the prediction.

For example, in one embodiment of the present invention, if a coming decrease in the actual speed v_{act} is predicted, the amplification K_{D} for the D element may be increased to counteract the decrease. Similarly, the amplifications Kₚ, K_{I} for the respective P and I elements may be reduced to counteract the decrease. Combinations of these adjustments of the amplification for the respective P, I and D elements may be employed to counteract the decrease, so that the amplification K_{D} for the D element is maintained or increased while at the same time the amplifications Kₚ, K_{I} for the respective P and I elements are reduced. The result of these amplification adjustments will be that a high torque M is provided earlier than in previously known solutions, thereby counteracting the decrease in the actual speed v_{act}. Thus it is for example possible for an overshoot in the zeroing pattern to be reduced or prevented on, for example, a downgrade where the actual speed v_{act} may be predicted to be reduced, e.g. by a reference-speed-regulating cruise control.

Similarly, the amplification K_{D} for the D element may be maintained or increased and/or the amplifications Kₚ, K_{I} for the respective P and I elements may be reduced to counteract a predicted increase in the actual speed v_{act}, since a low torque M is then provided earlier than in previous known solutions. It is thus for example possible for an undershoot in the zeroing pattern to be reduced or prevented on, for example, an upgrade where the actual speed v_{act} may be predicted to be increased, e.g. by a reference-speed-regulating cruise control.

In one embodiment, the amplifications Kₚ, K_{I} for the respective P and I elements may be given values which are substantially half the magnitude of the respective values of these amplifications on level roads if an overshoot or undershoot is predicted to occur.

The adjustments of the amplifications Kₚ, K_{I}, K_{D} for the respective P, I and D elements therefore affect the torque M through manipulation of the regulator's amplification parameters Kₚ, K_{I}, K_{D}, thereby also in practice achieving an effect upon the actual speed v_{act} which corresponds to a change in the reference speed v_{ref} of a reference-speed-regulating cruise control.

One skilled in the art will appreciate that a method for improving a zeroing pattern for a speed regulator according to the present invention may also be implemented in a computer programme which, when executed in a computer, causes the computer to conduct the method. The computer programme usually takes the form of a computer programme product 503 stored on a digital storage medium and is contained in a computer-readable medium of the computer programme product. Said computer-readable medium comprises a suitable memory, e.g. ROM (read-only memory), PROM (programmable read-only memory), EPROM (erasable PROM), flash memory, EEPROM (electrically erasable PROM), a hard disc unit, etc.

FIG. 5 depicts schematically a control unit 500 which corresponds to or is part of the speed regulator 120 according to the present invention. The control unit 500 comprises a calculation unit 501 which may take the form of substantially any suitable kind of processor or microcomputer, e.g. a circuit for digital signal processing (digital signal processor, DSP), or a circuit with a predetermined specific function (application specific integrated circuit, ASIC). The calculation unit 501 is connected to a memory unit 502 which is situated in the control unit 500 and which provides the calculation unit with, for example, the stored programme code and/or the stored data which the calculation unit needs to enable it to perform calculations. The calculation unit is also adapted to storing partial or final results of calculations in the memory unit 502.

The control unit 500 is further provided with respective devices 511, 512, 513, 514 for receiving and sending input and output signals. These input and output signals may comprise waveforms, pulses or other attributes which the input signal receiving devices 511, 513 can detect as information and which can be converted to signals which the calculation unit 501 can process. These signals are then conveyed to the calculation unit. The output signal sending devices 512, 514 are arranged to convert signals received from the calculation unit in order, e.g. by modulating them, to create output signals which can be conveyed to other systems on board the vehicle, e.g. the engine system 130.

Each of the connections to the respective devices for receiving and sending input and output signals may take the form of one or more from among a cable, a data bus, e.g. a CAN (controller area network) bus, a MOST (media oriented systems transport) bus or some other bus configuration, or a wireless connection.

One skilled in the art will appreciate that the aforesaid computer may take the form of the calculation unit 501 and that the aforesaid memory may take the form of the memory unit 502.

One aspect of the present invention is a proposed speed regulator adapted to improving a zeroing pattern for an actual speed v_{act} towards a target speed v_{des}. The speed regulator 120 according to the present invention is adapted to being primed on the basis of knowledge about a road section ahead of the vehicle, whereby the magnitude of at least one fluctuation of the zeroing pattern relative to the target speed v_{des} is reduced.

The priming brings forward in time, on the basis of knowledge about the road section ahead, at least one of the speed regulator's guiding measures so that it takes place earlier than if said knowledge was ignored or not available.

One skilled in the art will also appreciate that the above system may be modified according to the various embodiments of the method according to the invention. The invention relates also to a motor vehicle, e.g. a truck or a bus, provided with at least one speed regulator adapted to improving a zeroing pattern for an actual speed v_{act} towards a target speed v_{des}.

The present invention is not restricted to the invention's embodiments described above but relates to and comprises all embodiments within the protective scope of the attached independent claims.

1. A method for operating a speed regulator which guides an engine system in a vehicle towards a target speed v_{des}, causing the vehicle to assume an actual speed v_{act} which describes a zeroing pattern towards the target speed v_{des}, the method comprising obtaining knowledge about a road section ahead of movement of the vehicle; feed-forwarding of the speed regulator based on the knowledge about a road section ahead of movement of the vehicle, for reducing a magnitude of at least one fluctuation in the zeroing pattern relative to the target speed v_{des}.

2. A method according to claim 1, wherein the feed-forwarding causes the speed regulator to use the knowledge about the road section ahead as a basis for executing at least one guiding measure for the actual speed v_{act} earlier than if the knowledge about the road section ahead was ignored.

3. A method according to claim 1, wherein the road section ahead comprises an upgrade.

4. A method according to claim 3, wherein the at least one fluctuation comprises an undershoot of the actual speed v_{act} close to a beginning of the upgrade.

5. A method according to claim 3, wherein the at least one fluctuation comprises an overshoot of the actual speed v_{act} close to a beginning of the upgrade.

6. A method according to claim 1, wherein the road section ahead comprises a downgrade.

7. A method according to claim 6, wherein the at least one fluctuation comprises an undershoot of the actual speed v_{act} close to a beginning of the downgrade.

8. A method according to claim 6, wherein the at least one fluctuation comprises an overshoot of the actual speed v_{act} close to a beginning of the downgrade.

9. A method according to claim 1, wherein the knowledge about a road section ahead of said vehicle is based on information related to at least one of the following:
topography,
road curvature,
traffic situation,
roadwork,
traffic density, and
road surface state.

10. A method according to claim 1, wherein the target speed v_{des} is a set speed vₛₑₜ of a cruise control of the vehicle.

11. A method according to claim 1, wherein the target speed v_{des} is a reference speed v_{ref} of a reference-speed-regulating cruise control.

12. A method according to claim 1, wherein the feed-forwarding is effected by altering the character of the speed regulator.

13. A method according to claim 12, wherein the alteration of the character of the speed regulator is effected by changing at least one amplification parameter for a regulating algorithm of the speed regulator.

14. A method according to claim 1, wherein the feed-forwarding is operable to cause an earlier demand for an engine torque of a magnitude which counteracts the at least one fluctuation.

15. (canceled)

16. A computer program product comprising a non-transitory computer-readable medium and a computer program which is contained in the medium, wherein the computer program comprises program code which, when the code is executed in a computer, causes the computer to perform the method according to claim 1.

17. A speed regulator configured for guiding an engine system in a vehicle towards a target speed v_{des}, wherein the vehicle assumes an actual speed v_{act} which describes a zeroing pattern towards the target speed v_{des}; the speed regulator is configured to be feed-forwarded based on knowledge about a road section ahead of the vehicle, whereby the magnitude of at least one fluctuation in the zeroing pattern relative to the target speed v_{des} is reduced.

18. A speed regulator according to claim 17, which is configured for being feed-forwarded based on the knowledge about the road section ahead, and for causing at least one guiding measure for the actual speed v_{act} to be executed earlier than if the knowledge was ignored.
